(19) United States
(12) Patent Application Publication
(10) Pub. No.: US 2025/0124472 A1
(43) Pub. Date: Apr. 17, 2025

(54) System and Method of Cataloging and Appraising Toys

(71) Applicant: Helena Tupling, Eastvale, CA (US)

(72) Inventor: Helena Tupling, Eastvale, CA (US)

(21) Appl. No.: 18/910,697

(22) Filed: Oct. 9, 2024

Related U.S. Application Data
(60) Provisional application No. 63/590,513, filed on Oct. 16, 2023.

(51) Int. Cl. G06Q 30/02

(52) U.S. Cl. CPC G06Q 30/0278

(57) ABSTRACT

The present invention relates to a dolls cataloging and appraising system that assists users in managing their Doll collections using a mobile application and a server system. The mobile application integrates advanced scanning capabilities, including barcode scanning and image recognition, to catalog Doll items, accessories, and memorabilia. The system employs a client-server architecture where the server system stores collection data, including market values, and provides secure access through an authentication module. The application updates the total collection value in real-time, offers manual entry options for unrecognized items, and facilitates the integration with auction sites for buying and selling items. A non-transitory computer-readable medium stores instructions for capturing images or codes of Doll items, identifying them, and updating the collection database. Users can organize their collections into custom folders and receive price alerts for items listed on marketplaces.

### CROSS-REFERENCE TO RELATED APPLICATION

The present application claims priority to, and the benefit of, U.S. Provisional Application No. 63/590,513 which was filed on Oct. 16, 2023, and is incorporated herein by reference in its entirety.

### FIELD OF THE INVENTION

The present invention generally relates to the field of collection management systems. More specifically, the present invention relates to a doll cataloging and appraising system designed for collectors. The system includes a mobile application that interacts with a server system, utilizing advanced scanning capabilities such as barcode scanning and image recognition to catalog doll items, accessories, and memorabilia. The server system houses modules for secure user authentication, integration with external services for market data retrieval, and a central database for storing collection details, enabling real-time appraisal and management of the collection's value. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, toy doll collectors often face challenges in managing and keeping track of their collections. Currently, users use notebooks, excels, notes, and more to make a list of their items. One common issue such individuals face is the difficulty in remembering the items and accessories they own, particularly as collections grow in size and diversity. As a result, individuals can inadvertently purchase duplicate items, resulting in wasted resources and space. Conversely, collectors may pass up opportunities to acquire rare or valuable items because they mistakenly believe they already own them.

Another challenge toy collectors face is the lack of awareness of the collection's current market value. Many collectors may not have the means or tools to monitor the fluctuating values of their items over time. The lack of pricing insight can lead to undervaluing and underselling their collection pieces, resulting in financial loss. Toy collectors desire a comprehensive system that helps collectors easily catalog and manage their collections and appraise their items in real time.

Therefore, there exists a long-felt need in the art for a system that enables toy collectors, particularly doll collectors, to efficiently catalog and manage their collections with ease. There is also a long-felt need in the art for a solution that prevents the accidental purchase of duplicate items by providing a comprehensive and easily accessible inventory of owned items. Additionally, there is a long-felt need in the art for a system that can accurately appraise and track the market value of a collector's items. Moreover, there is a long-felt need in the art for a platform that integrates seamlessly with auction sites and marketplaces, providing real-time market data and facilitating direct sales transactions. Furthermore, there is a long-felt need in the art for a secure and user-friendly tool that offers intuitive features like barcode scanning and image recognition for quick and accurate cataloging. Finally, there is a long-felt need in the art for an all-in-one solution that enriches the collecting experience, providing insights into market trends, item rarity, and collection value.

The subject matter disclosed and claimed herein, in one embodiment thereof, comprises a doll cataloging and appraising system designed to assist collectors in managing their doll collections. The system includes a mobile application and a server system to provide advanced scanning capabilities such as barcode scanning and image recognition to catalog doll items, accessories, and memorabilia accurately. The mobile application interfaces with the server system using a client-server architecture, allowing users to scan items, automatically fetch relevant data, and store securely in a central database. The server system includes an API module that integrates with external services for market analysis, sales tracking, and auction site connectivity, offering users real-time appraisals and market insights. The mobile application also features an intuitive user interface that displays the total collection value in real time, provides alerts for price changes, and allows for manual item entry if scanning fails, ensuring a comprehensive and tailored solution for collectors.

In this manner, the doll cataloging and appraising system of the present invention accomplishes all of the foregoing objectives and offers a robust solution for toy collectors, particularly those with extensive doll collections. The system helps prevent duplicate purchases and underselling of valuable items. Through seamless integration with auction sites and real-time market data, the system empowers collectors to make informed buying and selling decisions, maximizing the value and enjoyment of their collections

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dolls cataloging and appraising system. The system comprises a mobile application configured to be executed on a mobile device, the mobile application includes a scanning module for barcode scanning and image recognition to catalog doll items, accessories, and related memorabilia. A server system includes a central database configured to store information related to the Doll items, including images, descriptions, market values, and historical data. An API module is configured to integrate with external services for image recognition, barcode scanning, and auction site connectivity. An authentication module is configured to securely authenticate a user to access the mobile application and ensure that the collection data stored in the central database is protected.

In yet another embodiment, a method for cataloging and appraising doll items in a collection using a doll cataloging and appraising system is disclosed. The method includes scanning a machine-readable code disposed on a doll item using a digital camera of a mobile device executing a mobile application, wherein the machine-readable code is a barcode or QR code, identifying the doll item based on the machine-readable code using a scanning module of the mobile application, adding the identified doll item to a collection database stored on a server system in communication with the mobile application, updating a total value of the collection in real-time based on the addition of the identified doll item, and displaying, on a user interface of the mobile application, the updated total value of the collection and details of the recently added doll item.

In another embodiment, the method also includes connecting the collection to one or more auction sites or marketplaces, selecting, by the user, an item from the doll collection stored in a central database of the system for listing the item on the one or more auction sites or marketplaces, posting the selected item for sale on the connected auction sites or marketplaces through the mobile application, and updating the central database with an updated collection cost and folders of the user's doll collection upon the successful sale of the item.

In another embodiment, a non-transitory computer-readable medium having instructions stored thereon, the instructions, when executed by a processor, causes the processor to perform a method for cataloging doll items. The method includes capturing an image or machine-readable code of a doll item using a camera of the mobile device, processing the captured image or machine-readable code to identify the doll item using image recognition or barcode scanning, transmitting the identification data of the doll item to a server system over a communication network, receiving, from the server system, information related to the identified doll item, including its market value, description, and historical data, displaying the received information on a user interface of a mobile application executed on the mobile device, and adding the identified doll item to a collection database maintained by the server system and updating a total value of the collection in real-time.

In still another embodiment, the method includes providing, on the user interface of the mobile application, an option to manually enter the details of the Doll item if the scanning of the machine-readable code is unsuccessful.

In yet another aspect, the method includes generating a price alert for the selected item, wherein the price alert is configured to notify the user when the price of the item on the auction sites or marketplaces matches a user-set price threshold.

In still yet another embodiment, the application allows the user to create custom folders within the collection database, and organize the identified doll items into the custom folders based on user-defined criteria.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates the overall architecture of the doll cataloging and appraising system of the present invention in accordance with the disclosed architecture;

FIG. 2 illustrates an exemplary home page displayed by the mobile application for initiating interaction with the system in accordance with the disclosed architecture;

FIG. 3 illustrates an exemplary user interface of the mobile application for scanning a barcode of an item for adding to the collection database in accordance with the disclosed architecture;

FIG. 4 illustrates another exemplary interface displayed by the mobile application of the present invention for displaying different items stored in the collection of a user in accordance with the disclosed structure;

FIG. 5 illustrates a user interface for displaying details of a selected item from the collection in accordance with the disclosed structure;

FIG. 6 illustrates an exemplary user interface displayed by the mobile application for enabling a user to interact with online marketplaces and auction sites to track recent sales and current listings in accordance with the disclosed architecture;

FIG. 7 illustrates a flow chart depicting a process of addition of Doll items to the collection in accordance with the disclosed architecture;

FIG. 8 illustrates a flow chart depicting a process of selling an item from the collection on an auction site using the mobile application of the present invention in accordance with the disclosed structure; and

FIG. 9 illustrates a flow chart depicting a process of sharing information of an item stored in a collection of a user in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that enables toy collectors, particularly Doll collectors, to efficiently catalog and manage their collections with ease. There is also a long-felt need in the art for a solution that prevents the accidental purchase of duplicate items by providing a comprehensive and easily accessible inventory of owned items. Additionally, there is a long-felt need in the art for a system that can accurately appraise and track the market value of a collector's items. Moreover, there is a long-felt need in the art for a platform that integrates seamlessly with auction sites and marketplaces, providing real-time market data and facilitating direct sales transactions. Furthermore, there is a long-felt need in the art for a secure and user-friendly tool that offers intuitive features like barcode scanning and image recognition for quick and accurate cataloging. Finally, there is a long-felt need in the art for an all-in-one solution that enriches the collecting experience, providing insights into market trends, item rarity, and collection value.

The present invention, in one exemplary embodiment, is a Doll cataloging and appraising system. The system includes a mobile application configured to be executed on a mobile device, the mobile application includes a scanning module for barcode scanning and image recognition to catalog Doll items, accessories, and related memorabilia. A server system includes a central database configured to store information related to the Doll items, including images, descriptions, market values, and historical data. An API module is configured to integrate with external services for image recognition, barcode scanning, and auction site connectivity. An authentication module is configured to securely authenticate a user to access the mobile application and ensure that the collection data stored in the central database is protected.

Reference will now be made in detail to the present preferred embodiments of the invention, examples of which are illustrated in the accompanying drawings. Wherever possible, the same reference numerals are used in the drawings and the description to refer to the same or like parts.

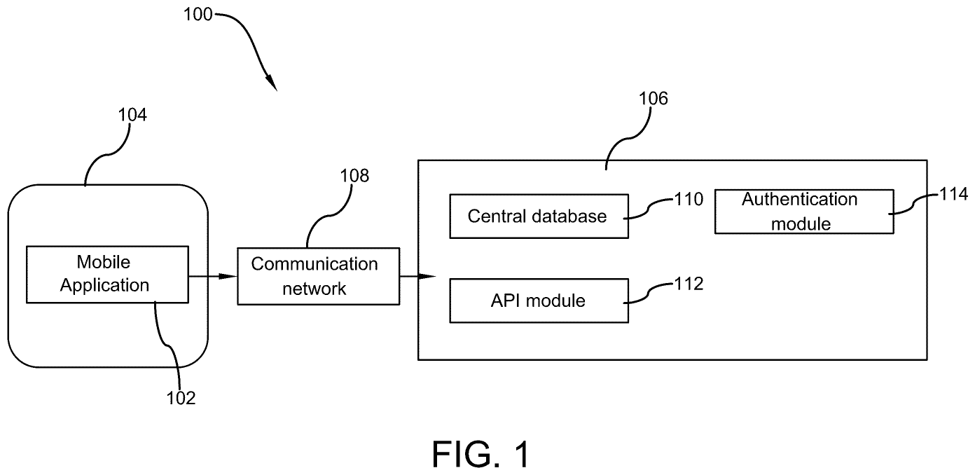

Referring initially to the drawings, FIG. 1 illustrates the overall architecture of dolls cataloging and appraising system 100 of the present invention in accordance with the disclosed architecture. The doll cataloging and appraising system 100 of the present invention is designed to assist collectors in managing, cataloging, and appraising their doll collections. More specifically, the doll collection system 100 has a client-server architecture and includes a mobile application 102. The application 102 is configured to enable users to interact with the system 100 on a mobile device 104 such as but not limited to a smartphone. The application 102 integrates advanced scanning capabilities (such as barcode scanning and image recognition) via a scanning module to help users easily catalog their Doll items, accessories, and related memorabilia.

A server system 106 is included in the doll cataloging system 100 and may use frameworks like Node.js (Express), Django (Python), or Spring Boot (Java). The server system 106 can use RESTful APIs to facilitate communication between the application 102 and the services offered by the server system 106. The application 102 and the server system 106 are adapted to communicate using a communication network 108 which can be a private or a public network. The server system 106 includes a central database 110 which is configured to store all the information related to doll items, including but not limited to: images, descriptions, market values, and historical data. The central database 110 is preferably in the form of a relational database, but can be in the form of any storage module. The collection information and personal details are encrypted to protect privacy and periodic data backups are automatically created to prevent loss of information.

The server system 106 also includes an API module 112 which allows the application 102 and the system 100 to integrate with external services for image recognition, barcode scanning, and auction site connectivity. APIs provided by the API module 112 can be used to fetch market data, sales history, and current listings of doll collections of a user. An authentication module 114 allows secure login mechanisms to the system 100 and authenticates the credentials of a user before providing access to the functionalities of the system 100. The module 114 ensures that the collection data of users stored in the database 110 is protected.

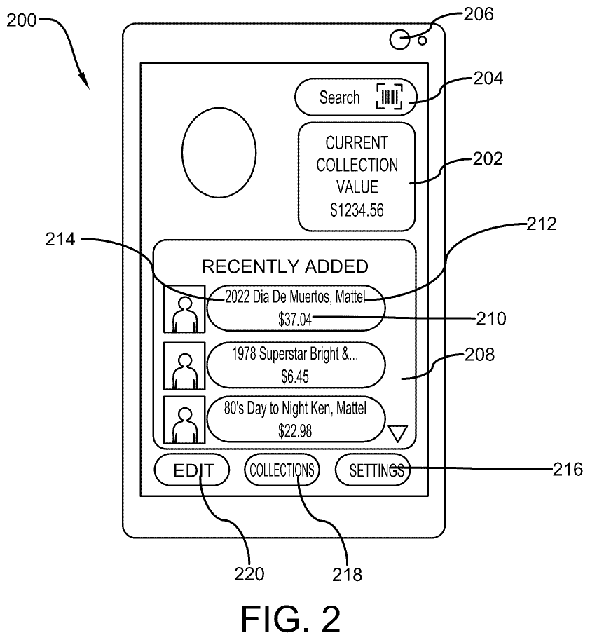

FIG. 2 illustrates an exemplary home page displayed by the mobile application 102 for initiating interaction with the system 100 in accordance with the disclosed architecture. The application 102 is comprised of a home page 200, which can be the first user interface displayed to a user. The home page 200 preferably provides a total value 202 of the collection of the logged-in user. The total value 202 is updated in real-time based on the items being added or removed from the collection. A barcode or QR code scanning option 204 is displayed which can be pressed to open the camera 206 of the mobile device 104 to scan a computer-readable code such as a barcode of a doll or a toy, wherein on successful scanning of the code, details of the doll or the toy are automatically added to the database 110.

The interface 200 also displays a list 208 of recently added items to the collection and can display the information such as cost 210, manufacturer 212, and name 214 of the added item. Additional control buttons such as Settings 216 allow a user to configure the settings of a profile, Collections 218 for displaying collection items, and an Edit button 220 for editing information of any recently added item.

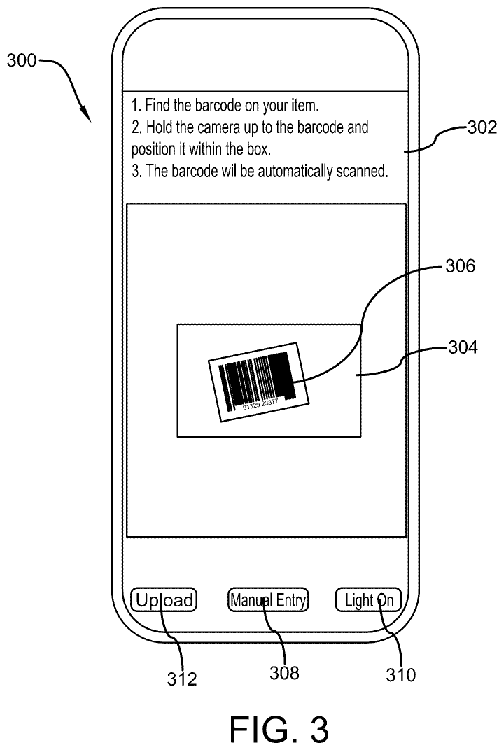

FIG. 3 illustrates an exemplary user interface of the mobile application 102 for scanning a barcode of an item for adding to the collection database in accordance with the disclosed architecture. The user interface 300 is displayed when the scanning option 204 is selected on the interface 200. The user interface 300 displays an instruction section 302 which provides the scanning instructions to users. A camera viewfinder section 304 displays a live camera feed to guide users in aligning the barcode 306 or item image within the frame.

A manual button 308 provides an option for manual data input if scanning fails or the item is not recognized. The manual button 308 redirects users to a form for entering item details (as described above) manually. A light on button 310 toggles the flashlight of the device 104 on or off for better scanning in low-light conditions. An upload button 312 when pressed opens the device's 104 gallery, allowing users to import an image such as a barcode for recognition of the item.

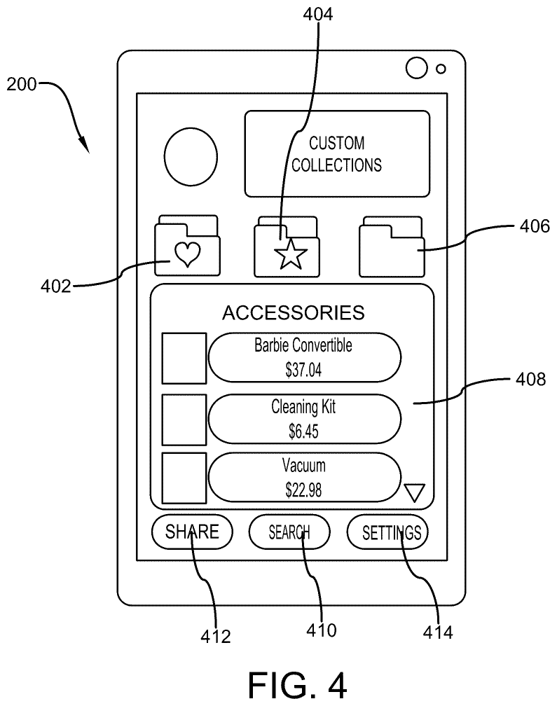

FIG. 4 illustrates another exemplary interface displayed by the mobile application 102 of the present invention for displaying different items stored in the collection of a user in accordance with the disclosed structure. The application 102 helps users easily catalog their doll items, accessories, and related memorabilia. As illustrated, the interface 400 displays different and independent folders 402,404,406 for dolls, accessories, and memorabilia respectively. It should be noted that any number of customized folders can be automatically prepared by the system 100 based on the items included in the collection of the users. The list display area 408 is configured to display different items stored in a folder when the folder is selected. For example, the area 408 can display a list of accessories from the collection when the accessories folder 404 is pressed by the user.

A search button 410 enables a user to search for any specific item from the collection, wherein the search can be performed by providing a name of the item. The search function 410 also helps users find accessories, adjacent items, missing collection items, and more. In some embodiments, the application 102 can receive voice commands from a user. A share button 412 enables a user to share a selected item with one or more users, auction sites, etc., wherein a unique link for viewing the item is generated when share button 412 is pressed. Display settings of the interface 400 can be updated or modified using the Settings button 414.

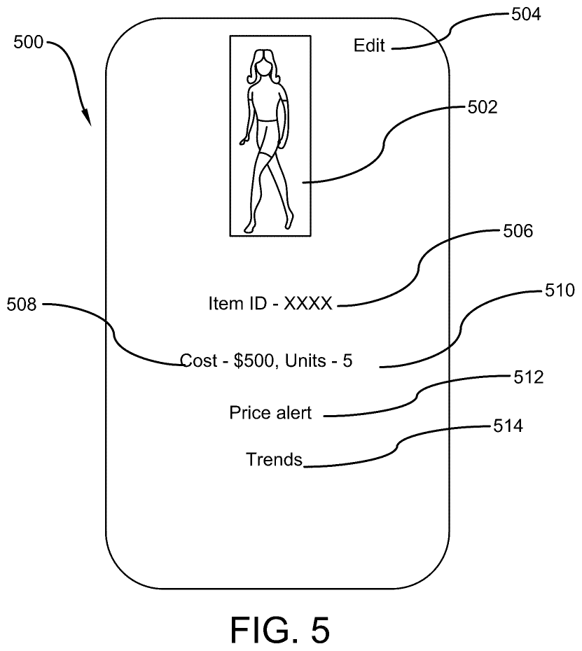

FIG. 5 illustrates a user interface for displaying details of a selected item from the collection in accordance with the disclosed structure. The interface 500 displays details stored in the collection database 110 of the system 100. A unique thumbnail or photo 502 of the item is displayed on the interface 500 and all the displayed information can be edited using the Edit button 504. The details displayed of the item includes but is not limited to: a unique item identifier 506 which uniquely identifies the item in the system 100. Details also include the cost 508 of the item and a number or stock 510 of the items in the collection of the user. A price of the item can be set by the user and a price alert 512 can be enabled which provides an alert by the application 100 when the price of the item on one or more auction sites matches the set price, enabling the user to sell or buy the item. Using a Trends button 514 a user can view the latest market trends and recent sales data for doll items included in the collection of the user. The trends can include graphical representations of real-time reselling of items on different auction sites and within the system 100. This allows users to identify the values of items, preventing them from underselling or overpricing their collectibles.

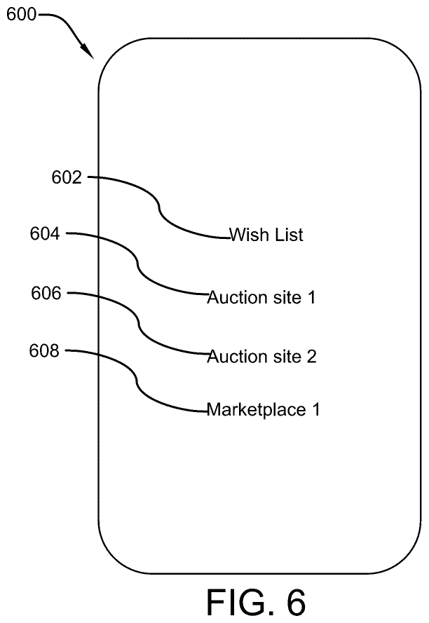

FIG. 6 illustrates an exemplary user interface displayed by the mobile application for enabling a user interact with online marketplaces and auction sites to track recent sales and current listings in accordance with the disclosed architecture. The application 102 integrates with online marketplaces and auction sites to track recent sales and current listings, providing users with real-time market data. Also, based on market trends and sales data, the application 102 can automatically offer an estimated value for each item in the collection of a user. The interface 600 provides a Wish list option 602 which allows a user to select items on different marketplaces and auction sites. The application can provide an alert when a price of a wish list item matches with the price set by the user for purchase.

The user can integrate and communication with one or more auction sites 604,606 and marketplaces 608 from where the user can purchase items and can also sell items from the collection. For selling, the user enters listing details (e.g., price, condition) within the application 102 and the application 102 posts the items for sale on the connected auction sites and marketplaces.

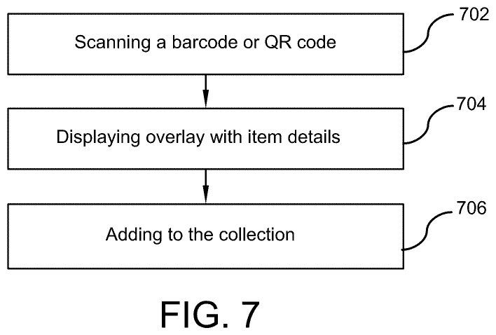

FIG. 7 illustrates a flow chart depicting a process of addition of doll items to the collection in accordance with the disclosed architecture. Initially, a machine-readable code such as a barcode or a QR code disposed on an item is scanned using the digital camera of the mobile phone 104 in which the mobile application 102 is installed (Step 702). When the code is successfully scanned, an overlay display with the item details is displayed in the application (Step 704). Further, on successful scanning, the item is added to the collection for monitoring and tracking purposes (Step 706). When the item is added to the collection, the total collection cost is automatically updated.

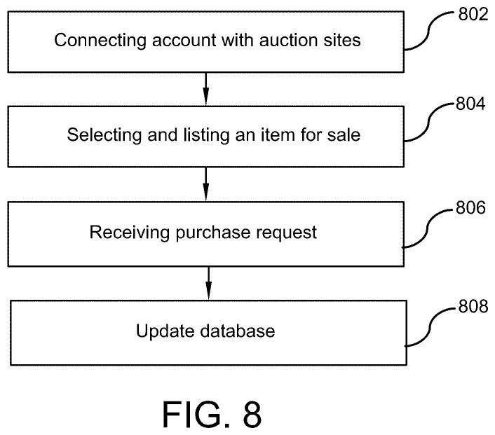

FIG. 8 illustrates a flow chart depicting a process of selling an item from the collection on an auction site using the mobile application of the present invention in accordance with the disclosed structure. Initially, the account of the user is connected or coupled with one or more auction site and/or marketplaces (Step 802). The sites can be any third-party website which allow buying and selling of toys, dolls, and other items. Then, a user selects one or more items from the collection thereof for listing the items on one or more selected auction site and/or marketplaces for selling (Step 804). Thereafter, if any user makes a purchase request of the listed item, then, a purchase request is provided by the application 102 to the user (Step 806). Once the item is sold, then, the collection database 110 is updated with the updated collection cost and updated folders present in the collection (Step 808).

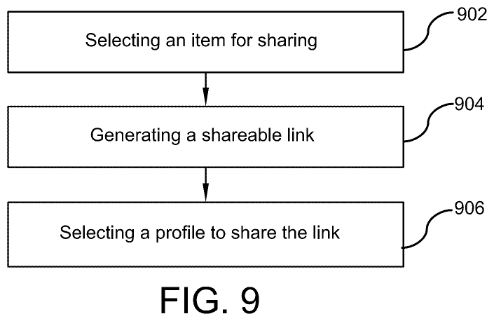

FIG. 9 illustrates a flow chart depicting a process of sharing information of an item stored in a collection of a user in accordance with the disclosed architecture. Initially, an item for which the information is to be shared is selected in the application 102 (Step 902). Once the item is selected, a shareable link is automatically generated by the application wherein the link directly provides the information of the selected item (Step 904). Thereafter, the link can be shared with one or more profiles of users or on one or more auction sites and marketplaces (Step 906).

The system 100 uniquely combines advanced scanning capabilities, real-time market integration, and personalized management tools within a single platform specifically designed for doll collectors. The system 100 and the application 102 simplifies the process of cataloging and appraising collections.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “dolls cataloging and appraising system”, “Doll cataloging system”, “Doll collection system”, and “system” are interchangeable and refer to the Doll cataloging and appraising system 100 of the present invention.

Notwithstanding the forgoing, Doll cataloging and appraising system 100 of the present invention can include any additional components to enhance the functionality and efficiency of Doll cataloging and appraising system 100. One of ordinary skill in the art will appreciate that the configuration and components of Doll cataloging and appraising system 100, as shown in the FIGS., are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A doll cataloging system comprising:
a mobile application configured to operate on a mobile device, wherein the mobile application and the mobile device can be used to scan and recognize an item in a doll collection using a barcode scanning or an image recognition;
a server system communicatively coupled to the mobile application via a communication network, the server system including:
a central database configured to store an information related to the doll collection, including an image, a description, a market value, and a historical data;
an API module configured to integrate an external service for fetching a market data, a sales history, and a current listings of a doll item; and
an authentication module adapted to authenticate a user credential and provide access to the doll cataloging system, wherein the mobile application is adapted to display a collection data and appraise a value of the doll collection in real-time based on the market data obtained through the server system.

2. The doll cataloging system of claim 1, wherein the communication network is comprised of a public network or a private network.

3. The doll cataloging system of claim 1, wherein the central database is comprised of a relational database.

4. The doll cataloging system of claim 1 further comprised of a backup module adapter to create a backup of the collection data stored in the central database.

5. The doll cataloging system of claim 1, wherein the mobile application is comprised of a search function adapted to search for a specific item within the doll collection.

6. The doll cataloging system of claim 1, wherein the mobile application can import an image from a gallery of the mobile device for item recognition.

7. The doll cataloging system of claim 1, wherein the server system is adapted to encrypt the collection data stored in the central database.

8. The doll cataloging system of claim 1, wherein the mobile application is comprised of a trends module for displaying a real-time market trend and a sales data for the doll items.

9. A doll cataloging system comprising:
a mobile application installed on a mobile device, the mobile application comprised of:
a home page configured to display a total value of a doll collection, the total value being updated in real-time as an item is added or removed to the mobile application;
a scanning module configured to scan a barcode or capture an image of a doll item to automatically catalog the item in a database;
a user interface displaying a recently added item to the doll collection with a detail including a cost, a manufacturer, and a name;
a server system in communication with the mobile application via a communication network, the server system comprising:
a central database configured to store an information related to a doll item, including an images, a description, a market value, and a historical data;
an API module adapted to integrate with an external service to fetch a market data, a sales history, and a current listings of a doll item; and
an authentication module adapted to authenticate a user credential and secure the collection data stored in the central database.

10. The doll cataloging system of claim 9, wherein the home page is comprised of a barcode scanning option to initiate the scanning module.

11. The doll cataloging system of claim 9, wherein the server system is comprised of an auction site integration module for tracking a sale and a listing of the doll item.

12. The doll cataloging system of claim 9, wherein the server system is adapted to generate and store a unique identifier for each doll item in the doll collection.

13. The doll cataloging system of claim 9, wherein the mobile application includes a price alert function adapted to notify a user when a price of a doll item matches a predefined value.

14. A doll cataloging system comprising:
a mobile application installed on a mobile device, the mobile application comprised of:
a home page configured to display a total value of a doll collection, the total value being updated in real-time as an item is added or removed to the mobile application;
a scanning module configured to scan a barcode or capture an image of a doll item to automatically catalog the item in a database;
a communication interface configured to transmit a scanned data to a server system for storage in a central database;
an interface configured to display a list of a doll item recently added along with corresponding a detail including a cost, a manufacturer, and a name;
a search function allowing a user to locate a specific doll item from the doll collection; and
an integration module configured to fetch a market data and a sales history for a doll items from an external service.

15. The doll cataloging system of claim 14, wherein the home page is comprised of a scanning option.

16. The doll cataloging system of claim 14 further comprised of a trends button adapted to display a recent market trend and a sales data of a doll item in a graphical format.

17. The doll cataloging system of claim 14, wherein the communication interface is adapted to integrate with an online auction site for posting a doll item for sale.

18. The doll cataloging system of claim 14 further comprised of a manual entry option that allows users to input a detail of a doll item.

19. The doll cataloging system of claim 14, wherein the search function is adapted to include a voice search capability.

20. The doll cataloging system of claim 14 further comprised of folder organization system that automatically categorizes a doll item, an accessories, and a memorabilia into a separate folder.
